(19) United States
(12) Patent Application Publication
(10) Pub. No.: US 2026/0056727 A1
(43) Pub. Date: Feb. 26, 2026

(54) ACCUMULATED DATA TRANSFER AMOUNT ACCESS

(71) Applicant: The Toronto-Dominion Bank, Toronto (CA)

(72) Inventors: Mark Anthony PARKER, Moorestown, NJ (US); Jonathan Joseph PRENDERGAST, West Chester, PA (US); Barry Wayne BAIRD, JR., Kennett Square, PA (US)

(73) Assignee: The Toronto-Dominion Bank, Toronto, ON (CA)

(21) Appl. No.: 18/814,953

(22) Filed: Aug. 26, 2024

(51) Int. Cl. G06F 8/65

(52) U.S. Cl. CPC G06F 8/65

(57) ABSTRACT

Systems and methods of initiating a transfer of a quantity of data are described. An accumulated data transfer amount for a periodic data transfer scheduled to be pushed to a primary storage location at a future date is determined. A transfer instruction directs a transfer amount from the accumulated-data transfer amount to a secondary storage location. A pull transfer of the transfer amount is initiated prior to the scheduled push transfer directly to the secondary storage location bypassing the primary storage location.

### TECHNICAL FIELD

The present application relates to data transfers and, more particularly, to determining whether to pull a data transfer amount prior to a scheduled push transfer date.

### BACKGROUND

Two general methods exist for transferring data from one location to another location: push transfers and pull transfers. A push transfer is a method of transfer where the transferor instructs data to be sent to the transferee, and a pull transfer is a method of transfer where the transferee instructs data to be sent from the transferor.

Push transfers may often be scheduled to be executed at periodic intervals between a transferor and a transferee. For example, although changes to data files at a primary storage location may occur at many times during a given week, data file updates from the primary storage location to secondary storage locations may be scheduled to occur at weekly intervals.

While the periodic scheduling of push transfers may provide efficiency to the updating process, there may be times when it is disadvantageous for a transferee to wait until the schedule future date to receive certain data. For example, there is a risk that the scheduled future date may coincide with computer or network failure and that the scheduled transfer may therefore be postponed. There is also a more serious risk that data available at the present time may be inadvertently or deliberately deleted prior to the scheduled future date. At the same time, early transfer of data via a pull transfer may provide for a data processing yield that would be otherwise unobtainable.

A data transfer loss may be associated with a pull transfer. Even so, in view of the risks associated with waiting, it may still be advantageous for a transferee to initiate a pull transfer prior to a scheduled future date. Systems and methods for determining when it is advantageous to initiate a pull transfer are desired.

### BRIEF DESCRIPTION OF THE DRAWINGS

Aspects are described in detail below, with reference to the following drawings:

FIG. 1 is a schematic operation diagram illustrating an operating environment of an example embodiment;

FIG. 2 is a high-level operation diagram of an example computing device;

FIG. 3 depicts an example simplified software organization of the example computing device of FIG. 2;

FIG. 4 is an example screen display of a client device;

FIG. 5 is a flow chart showing operations performed by a system, in accordance with an aspect of the present application;

FIG. 6 shows a user interface, in accordance with an aspect of the present application; and

FIG. 7 is a flow chart showing operations performed by a system, in accordance an aspect of the present application.

Like reference numerals are used in the drawings to denote like elements and features.

### DETAILED DESCRIPTION

In accordance with some aspects of the present disclosure, there is provided a system comprising a communications module, a processor coupled to the communications module, and a memory coupled to the processor. The memory storing processor-executable instructions which, when executed, configure the processor to: provide a client portal over the communications module to a client device corresponding to a client; receive an accumulated-resource amount corresponding to the client, the accumulated-resource amount scheduled to be pushed to a first logical storage location at a future date; receive a transfer instruction from the client portal to direct a transfer amount from the accumulated-resource amount to a second logical storage location which is different from the first logical storage location; and initiate a pull transfer of the transfer amount to the second logical storage location prior to the future date bypassing the first logical storage location.

In some aspects, the memory may store processor-executable instructions which, when executed, configure the processor to: retrieve a resource-transfer modifier associated with the second logical storage location, the resource-transfer modifier adjusting the transfer amount; determine a total-transfer modifier based at least in part on the resource-transfer modifier, the total-transfer modifier adjusting the transfer amount; provide the total-transfer modifier to the client portal; or receive a client confirmation from the client portal to initiate the pull transfer.

In some aspects, the memory may store processor-executable instructions which, when executed, configure the processor to: store at least a portion of the transfer instruction in a repository; or schedule the transfer instruction to occur according to a period.

In some aspects, the memory may store processor-executable instructions which, when executed, configure the processor to: initiate a push transfer of at least a portion of a resource amount from the first logical storage location to the second logical storage location according to the transfer instruction; or generate and provide to the client portal the accumulated-resource amount and the resource amount from the first logical storage location.

In accordance with some aspects of the present disclosure, there is provided a system comprising a communications module, a processor coupled to the communications module, and a memory coupled to the processor. The memory stores processor-executable instructions which, when executed, configure the processor to: determine an accumulated-resource amount associated with a client, the accumulated-resource amount scheduled to be pushed to a first logical storage location at a future date; receive a transfer instruction to direct a transfer amount from the accumulated-resource amount to a second logical storage location which is different from the first logical storage location; and initiate a pull transfer of the transfer amount to the second logical storage location prior to the future date bypassing the first logical storage location.

In some aspects, the memory may store processor-executable instructions which, when executed, configure the processor to: determine a total-transfer modifier based at least in part on a resource transfer modifier, the total-transfer modifier adjusting the transfer amount.

In some aspects, the memory may store processor-executable instructions which, when executed, configure the processor to: store at least a portion of the transfer instruction in a repository.

In some aspects, the memory may store processor-executable instructions which, when executed, configure the processor to: schedule the transfer instruction to occur according to a period.

In some aspects, the memory may store processor-executable instructions which, when executed, configure the processor to: initiate a push transfer of at least a portion of a resource amount from the first logical storage location to the second logical storage location according to the transfer instruction.

In accordance with some aspects of the present disclosure, there is provided a method comprising: retrieving, by a client portal, an accumulated-resource amount corresponding to a particular client, the accumulated-resource amount scheduled to be pushed to a first logical storage location at a future date; displaying an interface for providing a transfer instruction from the client portal to direct a transfer amount of the accumulated-resource amount to a second logical storage location which is different than the first logical storage location; and initiate a pull transfer of the transfer amount to the second logical storage location prior to the future date bypassing the first logical storage location.

In some aspects, the method may: retrieve a resource-transfer modifier associated with the second logical storage location; determine a total-transfer modifier based at least in part on the resource-transfer modifier; provide the total-transfer modifier to the client portal; or receive a client confirmation from the client portal to initiate the pull transfer.

In some aspects, the method may: store at least a portion of the transfer instruction in a repository.

In some aspects, the method may: initiate a push transfer of at least a portion of a resource amount from the first logical storage location to the second logical storage location according to the transfer instruction; or generate and provide to the client portal the accumulated-resource amount and the resource amount from the first logical storage location.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Open Banking refers to the use of open APIs that enable third-party developers to build applications and services around a financial institution. In practice, most of the applications so developed relate to Fintech. Open Banking provides Fintech providers with access to customer data stored by one or more financial institutions, allowing for the creation of aggregation platforms to facilitate financial planning and advice, and services to help customers compare product features across financial institutions.

A financial institution may periodically update a Fintech provider at scheduled intervals. In some implementations, the periodic updates may comprise a periodic transfer of data from the financial institution to the Fintech provider, i.e., a periodic push transfer. In some aspects, the financial institution may periodically transfer some or all of the relevant resources accumulated since the previous transfer to the Fintech provider. In some instances, the Fintech provider may initiate a transfer of accumulated resources, i.e., a pull transfer, prior to a future scheduled date of periodic push transfer. In some aspects, a customer of the Fintech provider may instruct the Fintech provider to perform a direct pull transfer of the accumulated resources directly to another, second, Fintech provider bypassing the original, first, Fintech provider. For example, the first Fintech provider may be in one country and the second Fintech provider may be in another country.

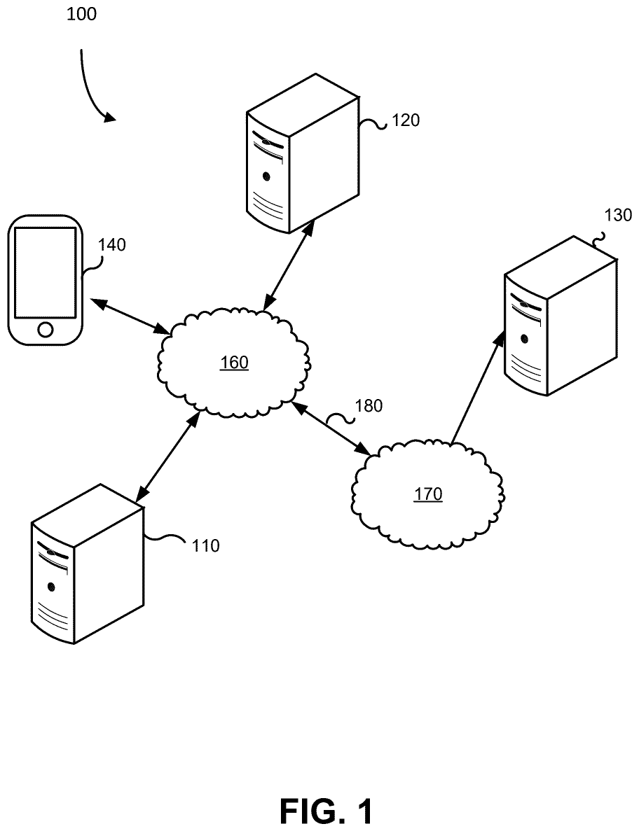

FIG. 1 is a schematic operation diagram illustrating an operating environment of an example embodiment.

As illustrated, the system 100 includes a first database management system 110, a second database management system 120, a third database management system 130, and a client device 140 in communication via networks 160, 170.

Each of the first database management system 110, the client device 140, the second database management system 120, and the third database management system 130, may be in geographically disparate locations. Put differently, one or more of the first database management system 110, the client device 140, the second database management system 120, and the third database management system 130 may be remote to others of the first database management system 110, the client device 140, the second database management system 120, and the third database management system 130. As described herein, the first database management system 110, the client device 140, and the second database management system 120 may communicate on a primary network 160. The third database management system 130 may be located on a secondary network 170. The third database management system 130 may be located in another administrative region, such as another country, province, or the like, from the first database management system 110, the client device 140, and the second database management system 120.

A communication link 180 or network interconnect may connect the primary network 160 to the secondary network 170. The communication within the primary network 160 may be associated with a particular transmission cost (e.g. transmission speed, amount of data, transmission limits, link security, etc.). The communication within the secondary network 170 may also be associated with a particular transmission cost (e.g. transmission speed, amount of data, transmission limits, link security, etc.). The communication link 180 may have a link cost associated with communication between the primary network 160 and the secondary network 170 that may be more difficult (e.g. slower, limited data, higher security, etc.) than communication within their respective networks 160, 170. In some aspects, the communication link 180 may comprise a protocol, such as the Society for Worldwide Interbank Financial Telecommunications (SWIFT) system that may be different than that of the communication within each respective network 160, 170 (e.g. TCP/IP).

The first database management system 110, the client device 140, the second database management system 120, and the third database management system 130 are computer systems. Computer systems may be, for example, a mainframe computer, a minicomputer, or the like. Computer systems may include one or more computing devices. For example, a computer system may include multiple computing devices such as, for example, database servers, computer servers, and the like. The multiple computing devices may be in communication using a computer network. For example, computing devices may communicate using a local-area network (LAN). In some aspects, computer systems may include multiple computing devices organized in a tiered arrangement. For example, a computer system may include middle-tier and back-end computing devices. In some aspects, a computer system may be a cluster formed of a plurality of interoperating computing devices.

The first, second, and third database management systems 110, 120, 130 may each be a single server, multiple servers, a server farm, or any other such arrangement of computing devices to implement computing server-like functionality. In some aspects, the first, second and third database management systems 110, 120, 130 may track, manage, and maintain owned resources belonging to respective entities. The resources may be represented in a database. The secure storage(s) may be provided internally within the first, second, and third database management systems 110, 120, 130 or externally. The secure storage(s) may, for example, be provided remotely from the first, second, and third database management systems 110, 120, 130. For example, the secure storage(s) may include one or more data centers. The data centers may, for example, store data with bank-grade security.

The resources may, for example, be computer code, spreadsheet data, and/or database information and may include image, text, audio and/or video files. Additionally or alternatively, the resources may be computing resources, such as memory or processor cycles. Additionally or alternatively, the resources may be digital goods, such as digital media resources; fonts, logos, photos and graphics; digital subscriptions; online advertisements; internet coupons; electronic tickets; electronic documentation; downloadable software and/or mobile apps; cloud-based applications and online games; virtual goods used within the virtual economies of online games and communities; workbooks; worksheets; planners; e-learning (online courses); webinars, video tutorials; blog posts; cards; patterns; website themes; and/or templates. Examples of digital media resources include e-books, downloadable music, internet radio, internet television and/or streaming media. The resources may be a specific type of digital goods known as digital assets, and may include photography, logos, illustrations, animations, audiovisual media, presentations, spreadsheets, digital paintings, word documents, electronic mails, websites, and a multitude of other digital formats and their respective metadata. Digital assets may be subject to digital rights management (DRM) and/or digital asset management (DAM). By way of further example, the resources may be database resources, and may represent stored value, such as financial instruments, including fiat currency and cryptocurrency. In at least some implementations, the resources may be or include digital goods which are exchange mediums. For example, the digital goods may be or represent monetary instruments.

The first database management system 110 may include a quantity of exploitable resources. The exploitable resources may include computer code, spreadsheet data, and/or database information and may include image, text, audio and/or video files. Additionally or alternatively, the exploitable resources may include computing resources, such as memory or processor cycles. Additionally or alternatively, the exploitable resources may include digital goods.

In some aspects, the first database management system 110 may include records for a plurality of exploitable resource accounts and at least some of the records may define a quantity of exploitable resources. A first entity may be associated with one or more accounts storing or otherwise reflecting owned resources, i.e., an owned resource account. The records may reflect a first quantity of stored resources that are associated with the first entity. Such resources may include owned resources. The amount of exploitable resources associated with the entity may be reflected by an exploitable resource definition defined in an associated exploitable resource record. The exploitable resource definition may be or include a balance defined in an associated record; for example, a bank balance. In some aspects, the exploitable resource definition may define one or more digital goods and/or digital assets that are associated with the first entity.

In some aspects, the first database management system 110 may, for example, be a computing client, such as a web client, an email client, an online chat client, and/or a video game client. In some aspects, the first database management system 110 may, for example, be a Fintech provider server and the first entity may be a customer of the respective Fintech provider operating the associated financial provider server. Examples of Fintech providers include Mint™, Tink™ and Plaid™. In some aspects, the first database management system 110 may, for example, be an associated financial institution server and the first entity may be a customer of the respective financial institution operating the associated financial institution server.

The second database management system 120 may include a quantity of accumulated resources. The accumulated resources may include computer code, spreadsheet data, and/or database information and may include image, text, audio and/or video files. Additionally or alternatively, the accumulated resources may include computing resources, such as memory or processor cycles. Additionally or alternatively, the accumulated resources may include digital goods.

In some aspects, the second database management system 120 may include records for a plurality of accumulated resource accounts and at least some of the records may define a quantity of accumulated resources. The first entity may be associated with one or more of the plurality of accumulated resource accounts, and the associated records may reflect a quantity of accumulated resources that are associated with the first entity. Such resources may include owned resources. An amount of accumulated resources associated with the first entity may be reflected by an accumulated resource definition defined in an associated accumulated resource record. The accumulated resource definition may be or include a balance; for example, a bank balance and/or an earned wage balance.

In some aspects, the second database management system 120 may, for example, be a computing server, such as a web server, an email server, an online chat server, and/or a video game server. In some aspects, the second database management system 120 may, for example, be an associated financial institution server and the first entity may be a customer of the respective financial institution operating the associated financial institution server. In some aspects, the second database management system 120 may be an Earned Wage Access (EWA) platform.

Earned wage access (EWA) is a financial service offered to employees providing access to some of their accrued wages before the end of their payroll cycle. EWA is also known as instant pay, earned income, early wage access, accrued wage access, salary advance scheme and/or on-demand pay. Employees may use an application to transfer earned wages to their bank account, debit card, or payroll card. Typically, such a transfer requires payment of a fee.

In some aspects, each of the accumulated resource accounts may be associated with one or more future dates. The one or more future dates associated with an accumulated resource account may represent one or more scheduled future dates for periodic data transfer. The periodic data transfer may be a push transfer from the second database management system 120 to another system, such as the first database management system 110.

In some aspects, the amount of accumulated resources associated with an entity may accrue over time. The accrual of accumulated resources may occur at a predetermined rate and the predetermined rate may be known to the first entity. For example, the accumulated resource definition may reflect $100.00 on a current date, and the first entity may know that this amount increases at a fixed rate, for example, by $50.00 per day.

The second database management system 120 may include an application programming interface (API) which allows other systems, such as, for example, the first database management system 110, to determine an accumulated data transfer amount for a periodic data transfer scheduled to be pushed at a future date. The API may also allow other systems, such as, for example, the first database management system 110, to initiate a data transfer, i.e., a pull transfer, from the second database management system 120 to the first database management system 110. The pull transfer may comprise some or all of the accumulated data transfer amount.

The second database management system 120 may periodically update the first database management system 110 at scheduled intervals. In some implementations, the periodic updates may comprise a periodic transfer of data from the second database management system 120 to the first database management system 110, i.e., a periodic push transfer. In some aspects, the second database management system 120 may periodically transfer some or all of the accumulated resource definition from an accumulated resource record at the second database management system 120 to an associated exploitable resource record at the first database management system 110. In some aspects, the accumulated resource record and the associated exploitable resource record may both be associated with the first entity. As a result of a periodic push transfer, in some implementations, the resource definition of the accumulated resource record may reflect a lower amount of resources or may become zero. As a further result of a periodic push transfer, in some aspects, the resource definition at the associated exploitable resource record may reflect the aggregate amount of the previous accumulated resource definition and the previous exploitable resource definition.

The periodic data transfer may occur at a variety of intervals. For example, the periodic data transfer may occur on a daily, weekly, biweekly, semimonthly, monthly, and/or bimonthly basis. Additionally or alternatively, the periodic data transfer may occur as a result of a resource definition reaching a certain amount. For example, in some aspects, the periodic data transfer may occur once a certain amount of data has been accumulated. In some aspects, the periodic data transfer may occur at such time as a resource definition reaches $100.00 or $500.00. Once a transfer occurs, the resource definition associated with the amount of accumulated resources may reflect a lower amount, and/or may revert to zero.

In some aspects, a data transfer from the second database management system 120 to the first database management system 110 may be initiated by the first management system i.e., a pull transfer. There may be, however, a data transfer loss amount associated with a pull transfer from the second database management system 120. The data transfer loss amount may be known, or it may be unknown. The data transfer loss amount may be fixed and/or variable. For example, a pull transfer may result in a data transfer loss amount of, for example, $10.00, or of, for example, 2% of the total amount transferred. As another example, the data transfer loss amount associated with a pull transfer may be $10.00 plus 2% of the amount transferred.

In some aspects, the first database management system 110 may collect information by tracking the amount and the periodicity of data transfers transfer from an accumulated resource record at the second database management system 120 to an associated exploitable resource record at the first database management system 110. The first database management system 110 may use the collected information to predict the amount and the date of the future push transfers from the accumulated resource record at the second database management system 120 to the associated exploitable resource record at the first database management system 110.

The first database management system 110 may also include records relating to risk associated with an insufficient amount of exploitable resources, and these records may be associated with the first entity. For example, it may be that the first database management system 110 includes records identifying various upcoming bills usually paid using some or all of the quantity of exploitable resources associated with the entity. These records may include the amount, due date and late fees associated with each of these upcoming bills. As a result, the first database management system 110 may determine that an upcoming bill will become due before the date of the next transfer and may further determine that there is presently an insufficient amount of exploitable resources available to pay the bill. As a result, the first database management system 110 may determine that a data processing penalty amount, i.e., a late fee, may be applied in connection with the bill when it is paid after the due date. The first database management system 110 may likewise determine that the data processing penalty amount may be avoided when the bill is paid before on or before the due date.

The third database management system 130 may include records for a plurality of third resource accounts and at least some of the records may define a quantity of resources associated with an entity. The records may reflect a third quantity of stored resources that are associated with a second entity located in a different administrative region than the first entity. Such resources may include owned resources. The amount of third resources that are owned by the second entity may be reflected by a third resource definition defined in an associated third resource record. The third resource definition may be or include a balance defined in the associated third resource record; for example, a bank balance. In some implementations, the resource definition may define one or more digital goods and/or digital assets that are associated with the third entity.

In some aspects, the third database management system 130 may, for example, be a digital asset resource server and the second entity may be a customer of a respective institution operating the digital asset resource server. In some aspects, the third database management system 130 may, for example, be an associated financial institution server and the second entity may be a customer of the respective financial institution operating the associated financial institution server. The associated financial institution may be, for example, a foreign financial institution.

The client device 140 is also a computing device. In some aspects, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed aspects. In certain aspects, the client device 140 may be associated with one or more users. The one or more users may be associated with the first entity, such as a user or client, having resources associated with the first database management system 110. In some implementations, a user may operate the client device 140 to cause the client device 140 to perform one or more operations consistent with the disclosed aspects. In some aspects, the client device 140 may include a smart card, chip card, integrated circuit card (ICC), and/or other card having an embedded integrated circuit. In some aspects, the client device 140 may be associated with the second entity having resources associated with the third database management system 130.

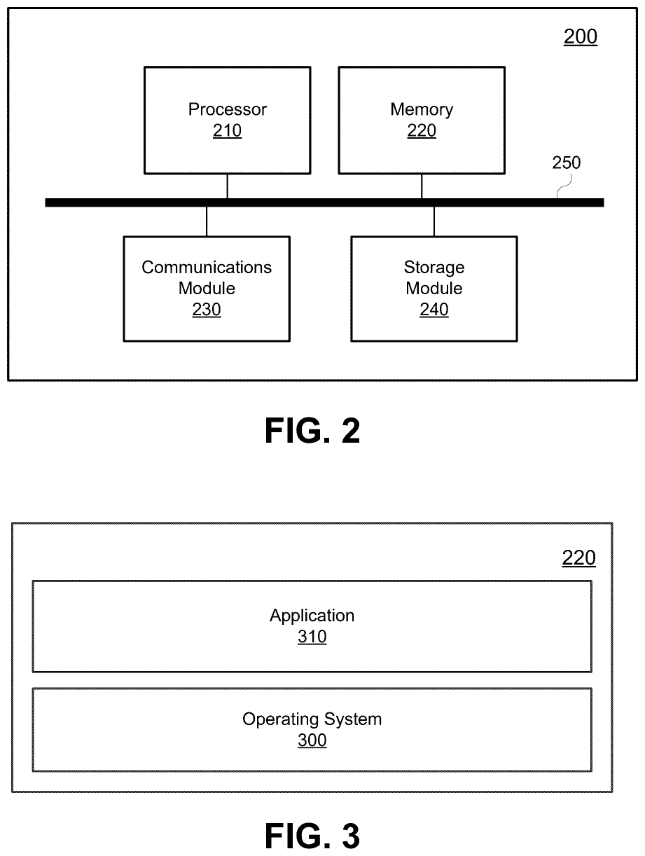

Referring to FIG. 2, a high-level operation diagram of an example computing device 200 is described. The example computing device 200 may be exemplary of the first database management system 110, the client device 140, the second database management system 120, and/or the third database management system 130.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like. The processor 210 may be a single core processor or may be a multi-core processor.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some aspects, all or a portion of the communications module 230 may be integrated into a component of the example computing device 200. For example, the communications module may be integrated into a communications chipset.

The storage module 240 allows the example computing device 200 to store and retrieve data. In some aspects, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some aspects, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some aspects, the storage module 240 may access data stored remotely using the communications module 230. In some aspects, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The example computing device 200 includes other components apart from those illustrated in FIG. 2 and the specific component set may differ based on whether the example computing device 200 is operating as the first database management system 110, the client device 140, the second database management system 120, and/or the third database management system 130. For example, the example computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the example computing device 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer device 200. As illustrated these software components include an operating system 300 and an application 310.

The operating system 300 is software. The operating system 300 allows the application 310 to access the processor 210, the memory 220, and the communications module 230. The operating system 300 may be, for example, UNIX™, Linux™, Microsoft™, Windows™, Apple™, Apple OSX™, Android™ or the like. In some aspects, the operating system 300 may be one or more virtual machines executing on a virtual machine platform.

The application 310 adapts the example computing device 200, in combination with the operating system 300, to operate as a device to a particular function. For example, the application 310 may cooperate with the operating system 300 to adapt a suitable aspect of the example computing device 200 to operate as the first database management system 110, the client device 140, the second database management system 120, and/or the third database management system 130.

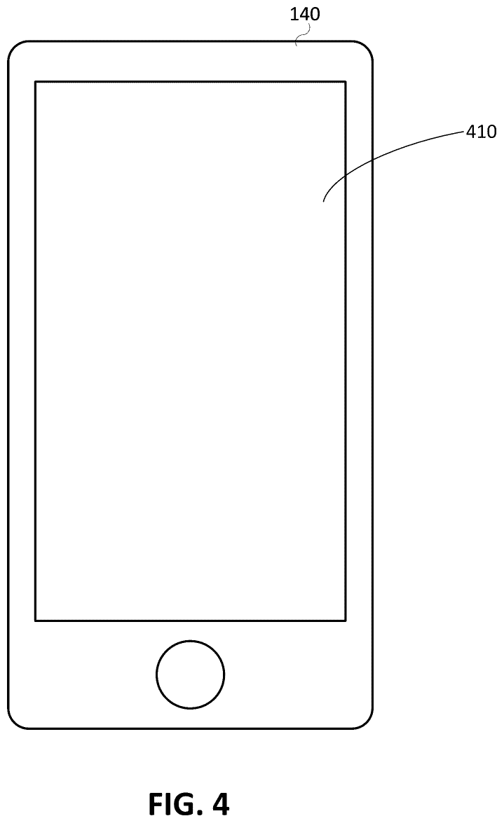

FIG. 4 shows the front of the client device 140 of FIG. 1. The client device 140 may be a personal computing device, such as a smart phone, as shown in FIG. 4. As previously described, the client device 140 may be a computing device of another type such as a laptop computer, a desktop computer, a tablet computer, a notebook computer, a hand-held computer, a personal digital assistant, a portable navigation device, a mobile phone, a wearable computing device, or any combination thereof.

As illustrated, the front of the client device 140 includes a display 410. The display 410 is a module of the smart phone aspect of the client device 140. The display 410 is for presenting graphics. The display 410 may be, for example, a liquid crystal display (LCD). In addition to being an output device, the display 410 may also be an input device. For example, the display 410 may allow touch input to be provided to the client device 140. In other words, the display 410 may be a touch sensitive display module. In a particular example, the display 410 may be a capacitive touch screen. As described herein, one or more of the database management systems 110, 120 may provide a client portal over the communications module 230 to the client device 140 for presentation on the display 410. The respective entity may provide instructions via the client portal to the respective database management system 110, 120 over the communications module 230.

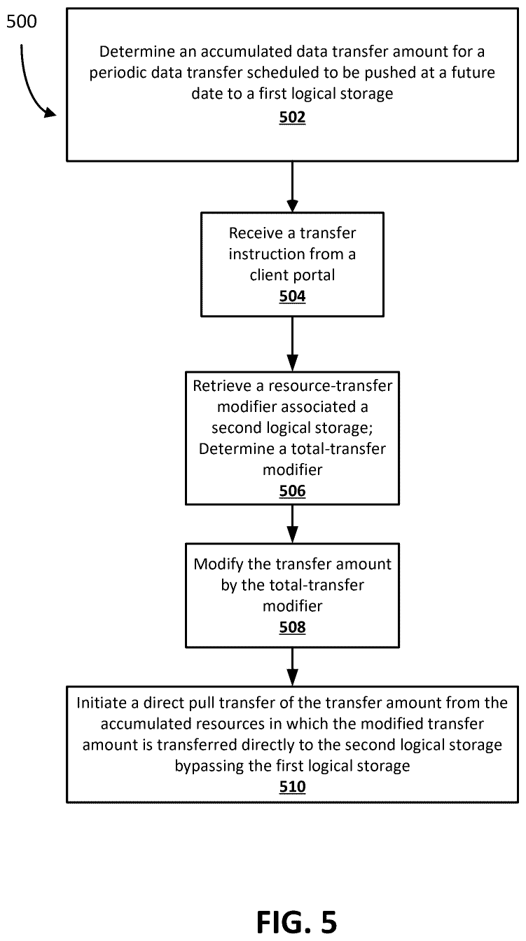

The operation of the first database management system 110 is described with reference to the flowchart of FIG. 5 which illustrates a method 500 for initiating a pull transfer of an accumulated data transfer amount. Operations 502 and onward are performed by one or more processors of a computing device 200, such as for example the processor 210 of a suitably configured instance of the example computing device 200, executing software such as, for example, a suitable instance of the application 310.

At the operation 502, the first database management system 110 determines an accumulated data transfer amount for a periodic data transfer scheduled to be pushed at a future date. For example, the first management system 110 may access one or more records of the second database management system 120 to determine the accumulated data transfer amount and to determine the next scheduled date of a push transfer to the first logical storage location. As noted, the accumulated data transfer amount may correspond to computer code, spreadsheet data, and/or database information and may include image, text, audio and/or video files. Additionally or alternatively, the accumulated resources may include computing resources, such as memory or processor cycles. Additionally or alternatively, the accumulated resources may include digital goods. In some aspects, the accumulated data transfer amount may be reflected by an accumulated resource definition defined in an associated accumulated resource record, such as an earned wage balance.

At the operation 504, the first database management system 110 receives a transfer instruction from the client portal executing on the client device 140. The transfer instruction may direct a transfer amount from the accumulated resources of the second database management system 120 to a second logical storage location of the third database management system 130.

At the operation 506, the first database management system 110 may retrieve a resource-transfer modifier associated with the second logical storage location of the third database management system 130. The resource-transfer modifier may may be fixed and/or variable. In some aspects, the resource-transfer modifier may include the link cost associated with communication over the communication link 180 between the primary network 160 and the secondary network 170. For example, the resource-transfer modifier may be a wire transfer loss associated with the transfer amount from the accumulated resources to the third database management system 130 located in another administrative region. In other aspects, the resource-transfer modifier may limit the amount of the transfer to below a transfer threshold and/or may increase the resource transfer modifier above the transfer threshold. In some aspects, the amount of the transfer may be split into more than one transfer such that each transfer amount is below the transfer threshold and each transfer amount has the resource transfer modifier applied thereto.

The first database management system 110 may also determine a total-transfer modifier based at least on the resource-transfer modifier or the data transfer loss amount associated with the pull transfer. As previously noted, the data transfer loss amount may be associated with a pull transfer from the second database management system 120 and, in this case, to the third database management system 130. The first database management system 110 may then provide the total-transfer modifier to the client portal for presentation on the display 410 of the client device 140. In some aspects, the first database management system 110 may wait for a confirmation from the client portal on the client device 140.

In some aspects, the client portal may provide a scheduling interface to the client device 140 to enable scheduling the transfer instruction at a scheduled future date. The client portal may provide the scheduled future date along with the transfer instruction to the first database management system 110. For example, if today is August 1 and the scheduled future date is August 5, the first database management system 110 may store at least a portion of the transfer instruction in a repository until the scheduled future date. The first database management system 110 may initiate one or more of the transfer instructions stored in the repository when the current date corresponds to the scheduled future date of the transfer instructions.

At the operation 508, the first database management system 110 may modify the transfer amount by the total-transfer modifier to provide a modified transfer amount. The total-transfer modifier amount may be provided to a provider's logical storage associated with the provider of the first database management system 110. A portion of the modified transfer amount may be subsequently transferred from the provider's logical storage to the respective logical storages of the providers of the second database management system 120 and/or the third database management system 130.

At the operation 510, the first database management system 110 may initiate a direct pull transfer of the transfer amount from the accumulated resources of the second database management system 120. The first database management system 110 may directly transfer the modified transfer amount to the second logical storage of the third database management system 130 over the communication link 180 and bypassing the first logical storage of the first database management system 110.

The first storage location may be associated with the first entity and may comprise one or more subsidiary storage locations associated with the first entity. The one or more subsidiary storage locations may reside at the first database management system 110 and/or the second database management system 120. The storage location may include one or more resource accounts including records defining one or more quantities of resources associated with the first entity. The records may reflect a quantity of stored resources that are associated with the first entity. Such resources may include owned resources.

The second location may be associated with the second entity and may comprise one or more subsidiary storage locations associated with the second entity. The one or more subsidiary storage locations may reside at the third database management system 130. The storage location may include one or more resource accounts including records defining one or more quantities of resources associated with the second entity. The records may reflect a quantity of stored resources that are associated with the second entity. Such resources may include owned resources.

In some aspects, the direct pull transfer of the accumulated data transfer amount may be performed subsequent to receiving from a client device 140 associated with the first entity, confirmation to initiate the pull transfer of the accumulated data transfer amount. Alternatively, in some aspects, the pull transfer of the accumulated data transfer amount may be performed by the first database managements system 110 automatically.

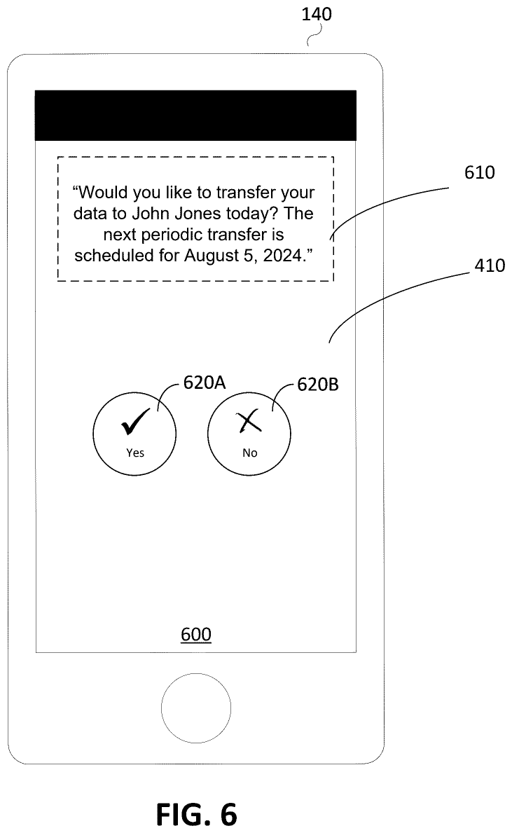

FIG. 6 shows a user interface for use in presenting a notification including a selectable option to initiate the pull transfer of an accumulated data transfer amount.

As illustrated, the display 410 of the client device 140 may present an example user interface 600. The example user interface 600 includes a prompt 610 and a set of response buttons 620A-620B.

The prompt 610 includes text such as may correspond to the determination at the operation 510. In the example illustrated in FIG. 6, the text recites, “Would you like to transfer your data to John Jones today? The next periodic transfer is scheduled for Aug. 5, 2024.” In this example, the client device 140 displays a more user-friendly name “John Jones” that corresponds to the name of the second entity associated with the second logical storage on the third database management system 130. In some aspects, reasoning related to one or more of: the total-transfer modifier, the data transfer loss amount, and/or the resource-transfer modifier may be provided.

Response button 620A is labeled “Yes” corresponds to an agreement to an offer to initiate a pull transfer of accumulated data transfer amount. Response button 620B is labeled “No” corresponds to a rejection of an offer to initiate a pull transfer of the accumulated data transfer amount.

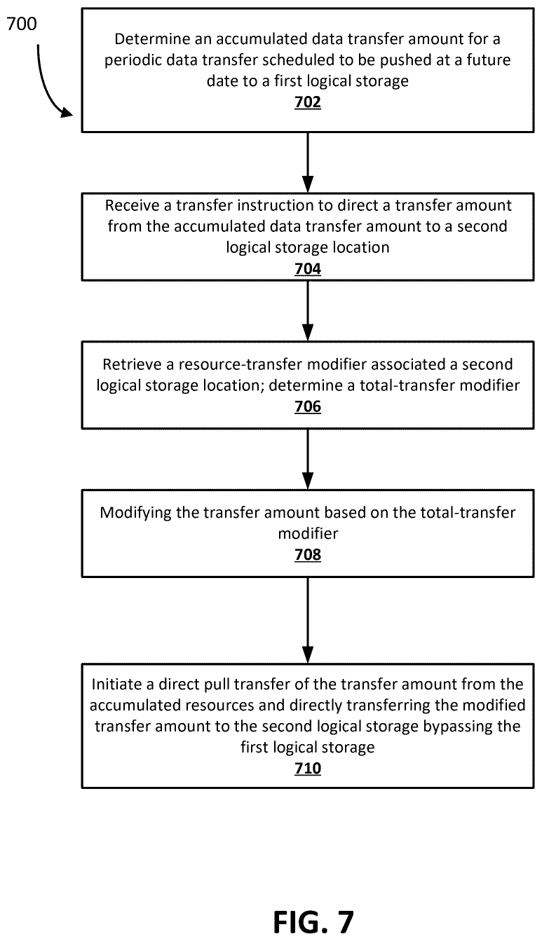

The operation of the first database management system 110 is described with reference to the flowchart of FIG. 7 which illustrates a method 700 for initiating a transfer of a quantity of data from an accumulated resource to a second logical storage location. Operations 702 and onward are performed by one or more processors of a computing device 200, such as for example the processor 210 of a suitably configured instance of the example computing device 200, executing software such as, for example, a suitable instance of the application 310.

At the operation 702, the first database management system 110 determines an accumulated data transfer amount associated with the first entity. The accumulated data transfer amount scheduled for a periodic data transfer push to a first logical storage location at a future date. The primary (i.e. first) storage location may be associated with the first entity and may reside at the first database management system 110, for example. The primary storage location may include one or more resource accounts including records defining one or more quantities of resources associated with the first entity. The records may reflect a quantity of resources that are associated with the first entity. Such resources may include owned resources.

In some aspects, the first database management system 110 may access one or more records of the second database management system 120 to determine the accumulated data transfer amount and to determine the next scheduled date of a push transfer to the primary storage location. As noted, the accumulated data transfer amount may correspond to computer code, spreadsheet data, and/or database information and may include image, text, audio and/or video files. Additionally or alternatively, the accumulated resources may include computing resources, such as memory or processor cycles. Additionally or alternatively, the accumulated resources may include digital goods. In some aspects, the accumulated data transfer amount may be reflected by an accumulated resource definition defined in an associated accumulated resource record, such as an earned wage balance.

For example, in some aspects, prior to determining an overall data amount in the second database management system 120, the first database management system 110 may determine the elapse of a time period. In some implementations, the elapse of the time period may, for example, correspond to the scheduled future date. In some implementations, the value of the time period may be determined via communication with a client device 140 associated with a first entity.

At the operation 704, the first database management system 110 may receive a transfer instruction over the communications module 230 to direct a transfer amount from the accumulated data transfer amount to a second logical storage location, which is different from the first logical storage location, and associated with the third database management system 130.

At the operation 706, in some aspects, the first database management system 110 may retrieve a resource-transfer modifier associated with the second logical storage location. The first database management system 110 may determine a total-transfer modifier. The resource-transfer modifier may may be fixed and/or variable. In some aspects, the resource-transfer modifier may include the link cost associated with communication over the communication link 180 between the primary network 160 and the secondary network 170. For example, the resource-transfer modifier may be a wire transfer loss associated with the transfer amount from the accumulated resources to the third database management system 130 located in another administrative region. In other aspects, the resource-transfer modifier may limit the amount of the transfer to below a transfer threshold and/or may increase the resource transfer modifier above the transfer threshold. In some aspects, the amount of the transfer may be split into more than one transfer such that each transfer amount is below the transfer threshold and each transfer amount has the resource transfer modifier applied thereto.

The first database management system 110 may also determine a total-transfer modifier based at least on the resource-transfer modifier or the data transfer loss amount associated with the pull transfer. As previously noted, the data transfer loss amount may be associated with a pull transfer from the second database management system 120 and, in this case, to the third database management system 130. The first database management system 110 may then provide the total-transfer modifier to the client portal for presentation on the display 410 of the client device 140. In some aspects, the first database management system 110 may wait for a confirmation from the client portal on the client device 140.

At the operation 708, the first database management system 110 may modify the transfer amount by the total-transfer modifier to provide a modified transfer amount. The total-transfer modifier amount may be provided to a provider's logical storage location associated with the provider of the first database management system 110. A portion of the modified transfer amount may be subsequently transferred from the provider's logical storage location to the respective logical storages of the providers of the second database management system 120 and/or the third database management system 130.

At the operation 710, the first database management system 110 may initiate a direct pull transfer of the transfer amount from the accumulated resources of the second database management system 120. The first database management system 110 may directly transfer the modified transfer amount to the second logical storage of the third database management system 130 bypassing the first logical storage of the first database management system 110. The transfer of the transfer amount may occur before the next scheduled date.

In some aspects, the transfer amount may comprise accumulated resources of the second database management system 120 and an amount in the first logical storage location.

In some aspects, the transfer amount may be directly transferred from the accumulate resources directly to the second logical storage location of the third database management system 130. In this aspect, the total-transfer modifier may be transferred from the first logical storage location to the provider's logical storage location when the first database management system 110 performs the direct transfer from the accumulated resources to the second logical storage location. In some aspects, a portion of the total-transfer modifier may be transferred from the first logical storage location and a corresponding portion of the total-transfer modifier may adjust the transfer amount.

In some aspect, the client portal may provide an amount of the first logical storage location of the first database management system 110 and an amount of accumulated resources of the second database management system 120. The client portal may provide an interface to select a portion of the amount of the first logical storage location and a portion of the amount of accumulated resources to be the transfer amount. The client portal may provide an interface for saving the transfer instruction for execution one or more times in the future. The client portal may provide an interface for performing the transfer instruction periodically. In some aspects, the total-transfer modifier may be reduced when the transfer instruction is to be performed periodically.

As noted, in some examples, the first entity may be associated with the accumulated data transfer amount. In such examples, prior to determining the elapse of the time period, the system 110 may provide a notification to the client device 140 associated with the first entity. The notification may include a selectable option to confirm the direct pull transfer. The first management system 110 may then receive the confirmation from the client device 140 associated with the first entity.

In some aspects, prior to initiating the transfer of the quantity of data from the accumulated resources to the second storage location, the system 110 may provide a notification to a client device 140 associated with a first entity associated with the accumulated data transfer amount. The notification may include a selectable option to provide the value of the quantity of data. The system 110 may then receive a value of the quantity of data from the client device 140.

In some aspects, the first database management system 110 may automatically initiate a transfer of a quantity of data from the accumulated resources to the primary storage location at the scheduled future date. In some implementations, the quantity of data may include the entirety of the accumulated resources. In some implementations, the quantity of data may include a portion of the accumulated resources. In some aspects, the value of the quantity of data may be received by a client device 140 associated with an entity associated with the accumulated data transfer amount.

Example aspects of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described aspects can be made. Therefore, the above discussed aspects are considered to be illustrative and not restrictive.

What is claimed is:

1. A system comprising:
a communications module;
a processor coupled to the communications module; and
a memory coupled to the processor, the memory storing processor-executable instructions which, when executed, configure the processor to:
provide a client portal over the communications module to a client device corresponding to a client;
receive an accumulated-resource amount corresponding to the client, the accumulated-resource amount scheduled to be pushed to a first logical storage location at a future date;
receive a transfer instruction from the client portal to direct a transfer amount from the accumulated-resource amount to a second logical storage location which is different from the first logical storage location; and
initiate a pull transfer of the transfer amount to the second logical storage location prior to the future date bypassing the first logical storage location.

2. The system according to claim 1, wherein the processor-executable instructions further configure the processor to: retrieve a resource-transfer modifier associated with the second logical storage location, the resource-transfer modifier adjusting the transfer amount.

3. The system according to claim 2, wherein the processor-executable instructions further configure the processor to: determine a total-transfer modifier based at least in part on the resource-transfer modifier, the total-transfer modifier adjusting the transfer amount.

4. The system according to claim 3, wherein the processor-executable instructions further configure the processor to: provide the total-transfer modifier to the client portal; and receive a client confirmation from the client portal to initiate the pull transfer.

5. The system according to claim 1, wherein the processor-executable instructions further configure the processor to: store at least a portion of the transfer instruction in a repository.

6. The system according to claim 5, wherein the processor-executable instructions further configure the processor to: schedule the transfer instruction to occur according to a period.

7. The system according to claim 1, wherein the processor-executable instructions further configure the processor to: initiate a push transfer of at least a portion of the transfer amount from the first logical storage location to the second logical storage location according to the transfer instruction.

8. The system according to claim 7, wherein the processor-executable instructions further configure the processor to: generate and provide to the client portal the accumulated-resource amount and the resource amount from the first logical storage location.

9. A system comprising:
a communications module;
a processor coupled to the communications module; and
a memory coupled to the processor, the memory storing processor-executable instructions which, when executed, configure the processor to:
determine an accumulated-resource amount associated with a client, the accumulated-resource amount scheduled to be pushed to a first logical storage location at a future date;
receive a transfer instruction to direct a transfer amount from the accumulated-resource amount to a second logical storage location which is different from the first logical storage location; and
initiate a pull transfer of the transfer amount to the second logical storage location prior to the future date bypassing the first logical storage location.

10. The system according to claim 9, wherein the processor-executable instructions further configure the processor to: determine a total-transfer modifier based at least in part on a resource transfer modifier, the total-transfer modifier adjusting the transfer amount.

11. The system according to claim 9, wherein the processor-executable instructions further configure the processor to: store at least a portion of the transfer instruction in a repository.

12. The system according to claim 9, wherein the processor-executable instructions further configure the processor to: schedule the transfer instruction to occur according to a period.

13. The system according to claim 9, wherein the processor-executable instructions further configure the processor to: initiate a push transfer of at least a portion of the transfer amount from the first logical storage location to the second logical storage location according to the transfer instruction.

14. A method comprising:
retrieving, by a client portal, an accumulated-resource amount corresponding to a particular client, the accumulated-resource amount scheduled to be pushed to a first logical storage location at a future date;
displaying an interface for providing a transfer instruction from the client portal to direct a transfer amount of the accumulated-resource amount to a second logical storage location which is different than the first logical storage location; and
initiate a pull transfer of the transfer amount to the second logical storage location prior to the future date bypassing the first logical storage location.

15. The method according to claim 14, further comprising: retrieving a resource-transfer modifier associated with the second logical storage location.

16. The method according to claim 15, further comprising: determining a total-transfer modifier based at least in part on the resource-transfer modifier.

17. The method according to claim 16, further comprising: providing the total-transfer modifier to the client portal; and receiving a client confirmation from the client portal to initiate the pull transfer.

18. The method according to claim 14, further comprising: storing at least a portion of the transfer instruction in a repository.

19. The method according to claim 14, further comprising: initiating a push transfer of at least a portion of the transfer amount from the first logical storage location to the second logical storage location according to the transfer instruction.

20. The method according to claim 19, further comprising: generating and providing to the client portal the accumulated-resource amount and the resource amount from the first logical storage location.
